(19) United States
(12) Patent Application Publication
(10) Pub. No.: US 2024/0411576 A1
(43) Pub. Date: Dec. 12, 2024

(54) DEDICATED HOST LIVE MIGRATION

(71) Applicant: International Business Machines Corporation, Armonk, NY (US)

(72) Inventors: Anindita Das, Gainesville, FL (US); Pushkar Joshi, Hanover, MD (US); Joshua McCready, San Marcos, TX (US); Daniel M. Flowers, Charlton, MA (US)

(21) Appl. No.: 18/208,171

(22) Filed: Jun. 9, 2023

(51) Int. Cl. G06F 9/455

(52) U.S. Cl. CPC G06F 9/45558; G06F 2009/45562; G06F 2009/4557; G06F 2009/45595

(57) ABSTRACT

A computer-implemented method for live migration of a logical dedicated host and virtual machines (VMs) associated therewith from a first physical server to a second physical server, in accordance with one aspect of the present invention, includes, in response to receiving a request to migrate a logical dedicated host from the first physical server, creating a clone of the logical dedicated host thereby creating a clone dedicated host. The clone dedicated host is provisioned on a second physical server. VMs are migrated from the logical dedicated host to the clone dedicated host. The migration is transparent such that user operations being performed on the VMs continue uninterrupted during the migration. In response to completion of the migrating of the VMs to the clone dedicated host, the logical dedicated host is caused to be de-provisioned from the first physical server.

### BACKGROUND

The present invention relates to infrastructure as a service, and more specifically, this invention relates to migration of dedicated hosts and their associated virtual machines.

Infrastructure as a Service (IaaS) is a cloud computing model where Cloud Service Providers (CSPs) provide on-demand virtualized compute, network, and storage resources in provider-managed data centers. Virtualized compute resources are typically offered in the form of virtual machines (VMs), dedicated hosts (DHs), and bare metal (BM) servers.

A physical compute server, also referred to herein as a physical server, is comprised of a set of server hardware (CPU, memory, network interfaces, etc), an operating system, and a hypervisor virtualization software stack. The CSP data center infrastructure may include a plurality of physical compute servers.

A dedicated host, also referred to herein as a logical dedicated host, is a logical representation of a physical compute server within the CSP infrastructure with inherent policies to assure single account tenancy of associated resources. FIG. 6 depicts a logical dedicated host entity 600. As shown, a logical dedicated host 602 generally may have defined logical attributes representing actual attributes of a physical computer, as well as features such as identity access management, workload status and metrics, etc. A physical compute server 604 runs the VMs 606. The user 608 interfaces with the logical dedicated host 602 via an interface for user access and management. An operator 610 responsible for maintaining the physical compute server 604 may interact with the logical dedicated host via an operator interface for CSP maintenance.

A dedicated host allows a user to have sole tenancy on a cloud server. This ensures that the user is the only user to have VMs on that server, which eliminates certain noisy neighbor scenarios and vectors of intrusion that could affect the user's workload.

As shown in FIG. 7, multiple logical dedicated hosts can be correlated into a single logical dedicated host group 700.

One problem with systems such as those shown in FIGS. 6 and 7 is that the physical compute servers underlying a logical dedicated host hardware will require maintenance from time to time, such as replacement of hardware, hardware upgrades, software updates, etc. Sometimes this maintenance is disruptive to the VMs hosted in the server. Disruptive maintenance on servers usually requires powering down the hardware, which in turn means the user's workload will be terminated while the maintenance occurs.

What is needed is a way to migrate a logical dedicated host and its VMs to another server without disruption or downtime of the user's workloads being processed by the logical dedicated host.

### SUMMARY

A computer-implemented method for live migration of a logical dedicated host and VMs associated therewith (e.g., VMs running on the logical dedicated host) from a first physical server to a second physical server, in accordance with one aspect of the present invention, includes, in response to receiving a request to migrate a logical dedicated host from the first physical server, creating a clone of the logical dedicated host thereby creating a clone dedicated host. The clone dedicated host is provisioned on a second physical server. VMs are migrated from the logical dedicated host to the clone dedicated host. The migration is transparent such that user operations being performed on the VMs continue uninterrupted during the migration. In response to completion of the migrating of the VMs to the clone dedicated host, the logical dedicated host is caused to be de-provisioned from the first physical server.

A computer program product for live migration of a logical dedicated host and virtual machines running thereon from a first physical server to a second physical server, in accordance with one aspect, includes one or more computer readable storage media, and program instructions collectively stored on the one or more computer readable storage media. The program instructions include program instructions to perform the foregoing method.

A system, in accordance with one aspect, includes a processor and logic integrated with the processor, executable by the processor, or integrated with and executable by the processor. The logic is configured to perform the foregoing method.

Other aspects of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one aspect of the present invention.

FIG. 2 is a flowchart of a method, in accordance with one aspect of the present invention.

FIG. 3 is a graphical representation of an example of a migration process performed in accordance with the method of FIG. 2.

FIG. 4 is a flowchart of a method, in accordance with one aspect of the present invention.

FIG. 5 is a diagram of an exemplary logical dedicated host migration process, in accordance with one aspect of the present invention.

FIG. 6 is a depiction of a logical dedicated host entity.

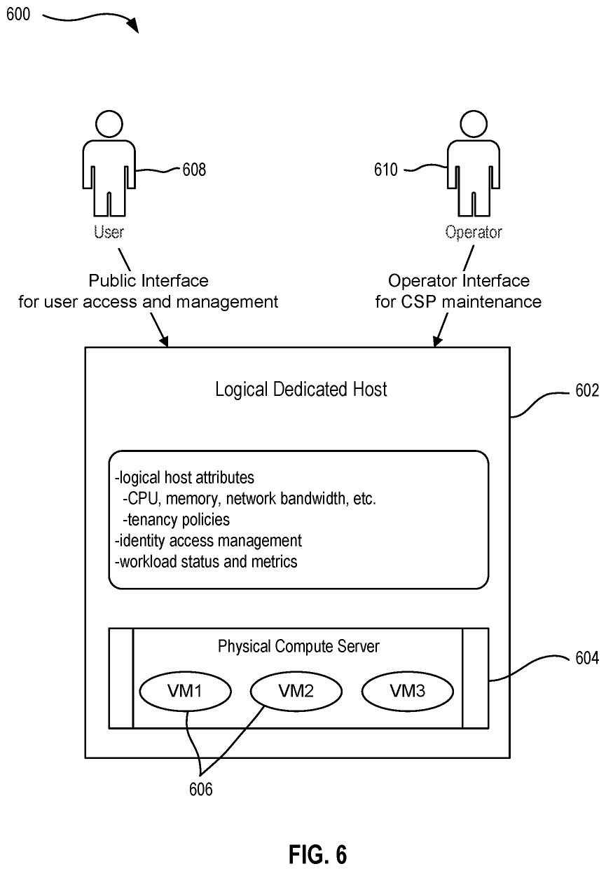

FIG. 7 is a depiction of a logical dedicated host group entity.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred approaches for systems, methods and computer program products for migrating a dedicated host and its associated VMs from one physical server to another while keeping the operation transparent to end users in a way that does not impede their ability to perform any operations on either the dedicated host or its VMs. A user can continue to use and operate the dedicated host in the same way without any downtime on the workloads run by VMs on the dedicated host.

In one general aspect of the present invention, a computer-implemented method for live migration of a logical dedicated host and VMs associated therewith (e.g., VMs running on the logical dedicated host) from a first physical server to a second physical server is provided. The method includes, in response to receiving a request to migrate a logical dedicated host from the first physical server, creating a clone of the logical dedicated host thereby creating a clone dedicated host. The clone dedicated host is provisioned on a second physical server. VMs are migrated from the logical dedicated host to the clone dedicated host. The migration is transparent such that user operations being performed on the VMs continue uninterrupted during the migration. In response to completion of the migrating of the VMs to the clone dedicated host, the logical dedicated host is caused to be de-provisioned from the first physical server.

This method for live migration of the logical dedicated host is transparent to the customer and does not require any customer intervention. Users such as customers of a cloud service are still able to use their logical dedicated hosts when it is undergoing live migration. For example, users are able to provision new VMs, delete an existing VM, and so on, all apparently on their logical dedicated host.

The present methodology for live migration is non-disruptive for the customers and does not incur any downtime for their resources.

Moreover, the present methodology helps ensure logical dedicated hosts that run users' workloads are properly maintained, upgraded and healthy, all while reducing any disruption due to maintenance of the hardware running the logical dedicated hosts.

In one approach, a resource configuration of the second physical server substantially matches the resource configuration of the first physical server. Thus, the clone dedicated host may be configured to have the identical logical resource configuration as the logical dedicated host. For example, the same type, quantity, etc. of resources allocated to the logical dedicated host on the first physical server may be allocated to the clone dedicated host on the second physical server. By selecting a second physical server having substantially the same resource configuration as the first physical server, the clone dedicated host is able to function essentially identically to the logical dedicated host. Likewise, having the clone dedicated host have the identical logical resource configuration as the logical dedicated host, a user's specifically selected strategic placement of VMs for benefits such as cost optimization, high availability, performance, and so on is effectively preserved after migration.

In one approach, the VMs running on the clone dedicated host are presented to the user as running on the logical dedicated host during and after the migrating of the VMs. Likewise, the clone dedicated host is presented to the user as the logical dedicated host after the migration of the logical dedicated host and its VMs. In this way, before, during, and after migration, the dedicated host that the user sees does not change, and all the VMs continue running on what the user sees as the original logical dedicated host.

In one approach, the method includes, in response to receiving the request, creating a migration object that is used to track the migration of the logical dedicated host. The migration object is acted on to create the clone dedicated host. The second physical server is identified, and the clone dedicated host is provisioned on the second physical server. In response to provisioning the clone dedicated host on the second physical server, the migration object is updated. The migration of the VMs is initiated. This procedure enables live migration of the logical dedicated host to the second physical server with no impact on operation or usability of the logical dedicated host and the VMs running thereon.

In one approach, causing the logical dedicated host to be de-provisioned includes deleting a dedicated host object, thereby prompting a scheduler microservice to de-provision the logical dedicated host. The migration object is updated to a completed state. The first physical server is then released and available for maintenance, use for other tasks, etc.

In one approach, a request to provision a new VM is received from the user during the migration of the VMs. In response to the request to provision the new VM, the new VM is provisioned on the clone dedicated host during the migrating of the VMs. In this way, the functionality provided by the logical dedicated host remains transparent to the user during the migration to the clone dedicated host. Moreover, by creating the new VM on the clone dedicated host, the new VM does not need to be migrated, thereby reducing computing resources and improving the overall operation of the computer performing the migrating.

In one approach, provisioning the new VM on the clone dedicated host includes determining an aggregate amount of available resources of the logical dedicated host and the clone dedicated host. A determination is made as to whether the aggregate amount of available resources is sufficient to fulfill the request to provision the new VM by comparing an amount of resources required by the new VM to the aggregate amount of available resources. In response to determining that the aggregate amount of available resources is sufficient to fulfill the request for provisioning the new VM, provisioning of the new VM on the clone dedicated host is scheduled. This sub-process may further include adding the new VM to a list of the VMs running on the clone dedicated host, and updating an amount of available resources of the clone dedicated host. This process has the technical effect of ensuring that sufficient available resources are present to properly run the new VM.

In one approach, a request to delete one of the VMs is received from the user during the migration of the VMs, and in response to said request, the one of the VMs is deleted during the migrating. In this way, the functionality provided by the logical dedicated host remains transparent to the user during the migration to the clone dedicated host. Moreover, by enabling deletion of a VM during the migration, the deleted VM does not need to be migrated; or, if the VM has already been migrated, enabling deletion thereof during the migration of the VMs frees resources of the clone dedicated host, in turn enabling such things as allowing provisioning of new VMs to the clone dedicated host.

A computer program product for live migration of a logical dedicated host and virtual machines running thereon from a first physical server to a second physical server, in accordance with one aspect, includes one or more computer readable storage media, and program instructions collectively stored on the one or more computer readable storage media. The program instructions include program instructions to perform any combination of the foregoing methodology.

A system, in accordance with one aspect, includes a processor and logic integrated with the processor, executable by the processor, or integrated with and executable by the processor. The logic is configured to perform any combination of the foregoing methodology.

Various aspects of the present disclosure are described by narrative text, flowcharts, block diagrams of computer systems and/or block diagrams of the machine logic included in computer program product (CPP) aspects. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product aspect (“CPP aspect” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as code for dedicated host live migration in block 150. In addition to block 150, computing environment 100 includes, for example, computer 101, wide area network (WAN) 102, end user device (EUD) 103, remote server 104, public cloud 105, and private cloud 106. In this approach, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

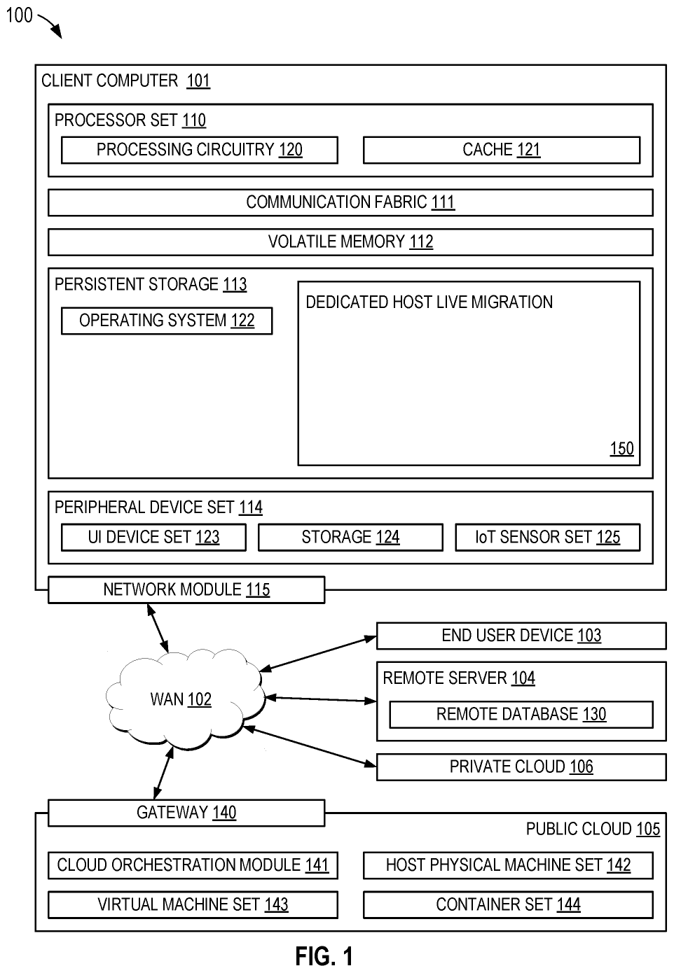

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various approaches, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some approaches, storage 124 may take the form of a quantum computing storage device for storing data in the form of qubits. In approaches where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some approaches, network control functions and network forwarding functions of network module 115 are performed on the same physical hardware device. In other approaches (for example, approaches that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some approaches, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some approaches, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other approaches a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this approach, public cloud 105 and private cloud 106 are both part of a larger hybrid cloud.

In some aspects, a system according to various approaches may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various approaches.

As noted above, disruptive maintenance on servers usually requires powering down the hardware, which in turn means a user's workload will be terminated while the maintenance occurs. This is especially problematic when users such as companies or their employees, customers, etc. rely on uninterrupted access to functionality and processes provided by VMs running on a logical dedicated host, e.g., in the cloud, on a service provider's network, etc. For example, a company may rely on processes running on VMs on a logical dedicated host for its day to day operations. Downtime of the logical dedicated host reduces the productivity of the company by slowing or stopping operations that rely on workloads being processed by VMs on the dedicated logical host. In another example, customers of a financial institution may rely on uninterrupted connection to the logical dedicated host of the financial institution to process credit card transactions. Downtime of the logical dedicated host results in failed transactions, and interruption of the business of the customer.

The methodology presented herein for live migration of a logical dedicated host avoids this downtime for the user's workload by moving the logical dedicated host and its VMs to new hardware without needing to power down or interrupt the workload. This migration is completely transparent to the user. The functionality of the D logical dedicated host and its VMs is uninterrupted during the migration to new hardware. This means that any work that is being done by the VMs can continue and that a user is able to create and/or remove VMs at will while maintaining the single tenancy.

The benefits of the methodology for live migration presented herein do not only extend to the user. Operators of the services that provide the logical dedicated hosts and VMs are able to shift workloads from one server to another at will without interrupting users' workloads and without the necessity of sending alerts or updates to the users, scheduling downtime when convenient for the user, etc. This lowers the amount of effort and time required to shift workloads to new servers and enables operators to quickly address concerns related to the underlying hardware.

In preferred aspects of the present invention, the methodology presented herein enables migration of a logical dedicated host and its associated VMs from one physical server to another while keeping the operation transparent to users of the logical dedicated host in a way that does not impede the users' ability to perform any operations on either the logical dedicated host or the VMs running thereon. Users can continue to use and operate the logical dedicated host in the same way without any downtime on the workloads run by VMs on the logical dedicated host.

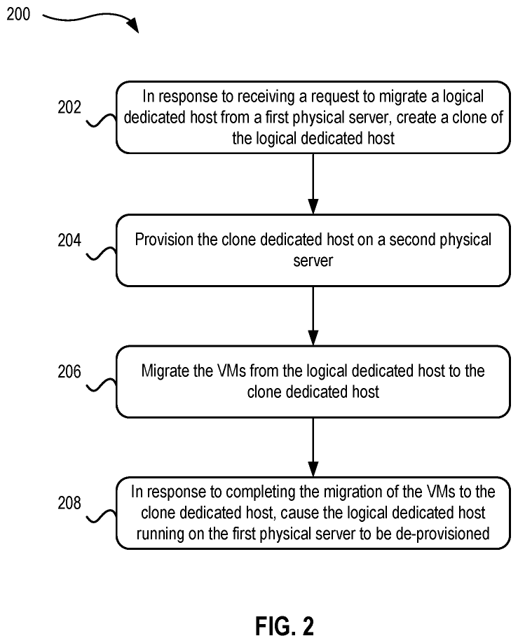

Now referring to FIG. 2, a flowchart of a method 200 for live migration of a logical dedicated host and VMs associated therewith (e.g., VMs running on the logical dedicated host) from a first physical server to a second physical server is shown according to one approach. The method 200 may be performed in accordance with the present invention in any of the environments depicted in the other FIGS. described herein, in various approaches. Of course, more or fewer operations than those specifically described in FIG. 2 may be included in method 200, as would be understood by one of skill in the art upon reading the present descriptions.

Each of the steps of the method 200 may be performed by any suitable component of the operating environment. For example, in various approaches, the method 200 may be partially or entirely performed by a computer, or some other device having one or more processors therein. The processor, e.g., processing circuit(s), chip(s), and/or module(s) implemented in hardware and/or software, and preferably having at least one hardware component, may be utilized in any device to perform one or more steps of the method 200. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 2, method 200 may initiate with operation 202, in which, in response to receiving a request to migrate a logical dedicated host from a first physical server, a clone of the logical dedicated host is created, thereby creating a clone dedicated host. An example of creating the clone by cloning the logical dedicated host object is presented below. Known cloning techniques may be adapted to create the clone dedicated host according to the teachings herein, in a manner that would become apparent to one skilled in the art after reading the present disclosure.

In operation 204, the clone dedicated host is provisioned on a second physical server. The second physical server is preferably within a same computing cluster as the first physical server. Preferably, the resource configuration of the second physical server substantially matches the resource configuration of the first physical server. For example, the same type of resources allocated to the logical dedicated host on the first physical server may be allocated to the clone dedicated host on the second physical server. Examples of resources include processor bandwidth, data storage capacity, memory allocation, etc.

In operation 206, the VMs are migrated from the logical dedicated host to the clone dedicated host. Examples of VM migration are presented in more detail below, any portion of which may be implemented in the method 200.

As described in more detail above, the migration of the VMs is transparent such that user operations being performed on the virtual machines continue uninterrupted during the migration. For example, new VMs may be provisioned during the migration of the VMs. An illustrative process for provisioning a new VM during the migration is described below. Likewise, a VM may be deleted during migration of the VMs.

In one approach, the virtual machines running on the clone dedicated host are presented to a user as running on the logical dedicated host during and after the migrating of the virtual machines, and the clone dedicated host is presented to the user as the logical dedicated host after completion of the migration of the logical dedicated host. Thus, for example, when some VMs are migrated to the clone dedicated host and others have not yet been migrated, the VMs are presented to the user as running on the logical dedicated host, even though they are presently dispersed across the two dedicated hosts.

In one exemplary approach, a hypervisor that supports live migration of VMs that are transparent to the user is used to migrate the VMs. One such hypervisor is a QEMU hypervisor. In one approach, a clone of a VM to be migrated is created on the clone dedicated host, and then the hypervisor copies memory contents, the state, the processes, registers, etc. to the clone dedicated host. Near the end of the migration, the hypervisor freezes the original VM, copies the last data (e.g., last dirty pages) to the cloned VM, and in response thereto, the user is then redirected to the VM on the clone dedicated host, which now has the state, memory contents, etc. of the original VM. The result is that the workload continues being processed such that the user should have no idea that the VM was moved. Note that in some cases where a compute-intensive operation is being performed on a VM while that particular VM is being live migrated, an insignificant delay of a few milliseconds during migration of the VM may occur. However, due to the insignificant duration of such delay and noting that the operation continues normally, the delay is not perceptible by a human user, and thus, the operation is considered uninterrupted.

Known techniques for live VM migration may be adapted for use in migrating VMs according to the teachings herein, in a manner that would become apparent to one skilled in the art after reading the present disclosure.

In operation 208, in response to completing the migration of the VMs to the clone dedicated host, the logical dedicated host running on the first physical server is caused to be de-provisioned. In one approach, this operation includes deleting a logical dedicated host object, thereby prompting a scheduler microservice to de-provision the logical dedicated host. The migration object is updated to a completed state. The first physical server is then released and available for maintenance, use for other tasks, etc. The clone dedicated host processes workloads for the user as if it were the original logical dedicated host.

The method 200 thus is able to migrate a logical dedicated host from a first server to a second server, where the clone dedicated host on the second server is substantially an exact clone of the logical dedicated host having the same configuration as the logical dedicated host, has the same network characteristics when it is within the same cluster, appears to be the logical dedicated host, and has the identical number of VMs in the same placement with identical characteristics. Moreover, no notice need be given to the user, and the user does not have to do anything with regards to the migration of the logical dedicated host and its VMs.

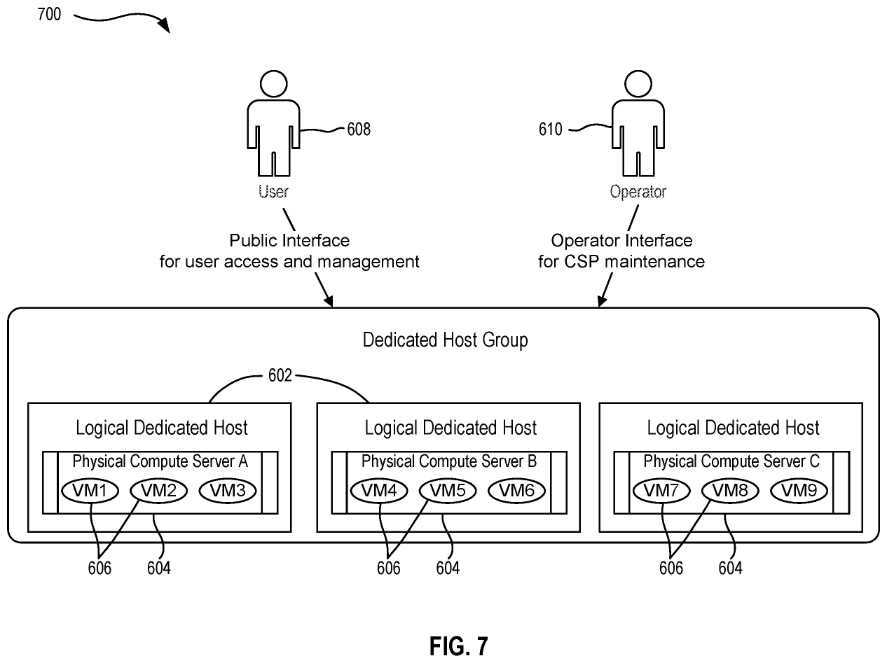

In the case of a dedicated host group, e.g., as shown in FIG. 7, if one of the logical dedicated hosts is to be migrated, the logical dedicated host may be migrated using the method 200 of FIG. 2. The clone dedicated host is then inserted into the dedicated host group. Similarly, if all of the logical dedicated hosts are to be migrated to one or more physical servers, the logical dedicated hosts may be migrated sequentially, one at a time, and each clone dedicated host is inserted into the dedicated host group upon completion of the respective migration. Accordingly, rather than simply moving VMs to other logical dedicated hosts within the group, a preferred approach proceeds as described in this paragraph so that it appears to the user is that nothing has changed.

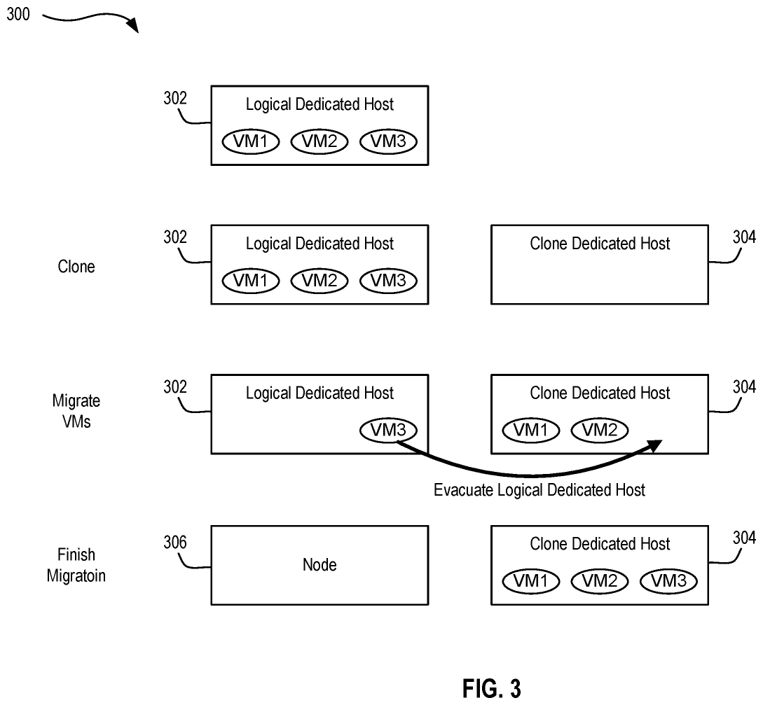

FIG. 3 is a graphical representation of an example of a migration process 300 performed in accordance with the method 200 of FIG. 2. As shown in FIG. 3, a logical dedicated host 302 has three VMs, VM-1, VM-2 and VM-3. In response to receiving a request to migrate the logical dedicated host 302, a clone dedicated host 304 is created. See also operations 202 and 204 of FIG. 2. The VMs are migrated to the clone dedicated host 304. See also operation 206 of FIG. 2. After all of the VMs are migrated, the migration of the logical dedicated host 302 is completed, leaving the underlying compute node 306 available for service, repurposing, etc. See also operation 208 of FIG. 2.

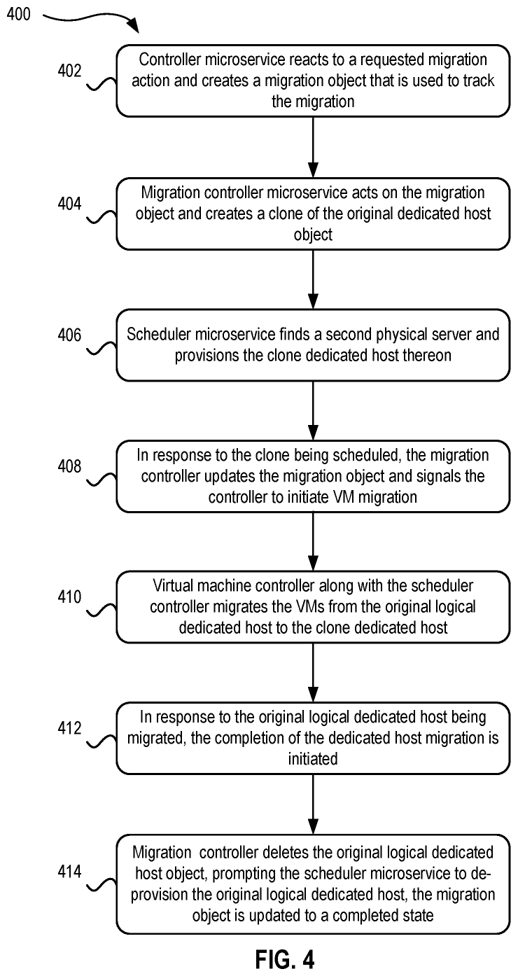

Now referring to FIG. 4, a flowchart of an exemplary method 400 for a live migration of a logical dedicated host and VMs associated therewith (e.g., VMs running on the logical dedicated host) from a first physical server to a second physical server is shown according to one approach. The method 400 may be performed in accordance with the present invention in any of the environments depicted in FIGS. 1-3, among others, in various approaches. Of course, more or fewer operations than those specifically described in FIG. 4 may be included in method 400, as would be understood by one of skill in the art upon reading the present descriptions.

Each of the steps of the method 400 may be performed by any suitable component of the operating environment. For example, in various approaches, the method 400 may be partially or entirely performed by a computer, or some other device having one or more processors therein. The processor, e.g., processing circuit(s), chip(s), and/or module(s) implemented in hardware and/or software, and preferably having at least one hardware component, may be utilized in any device to perform one or more steps of the method 400. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 4, method 400 may initiate with operation 402, where a controller microservice reacts to a requested migration action and creates a migration object that is used to track the migration.

In operation 404, the migration controller microservice acts on the migration object and creates a clone of the original dedicated host object.

In operation 406, a scheduler microservice finds a second physical server and provisions the clone dedicated host thereon. The original logical dedicated host and the clone dedicated host are labeled to indicate their roles allowing the scheduler to make appropriate decisions on VM placement when the VMs are migrated or new VMs are provisioned.

In operation 408, in response to the clone being scheduled, the migration controller updates the migration object and signals the controller to initiate VM migration.

In operation 410, responsive to a request, the virtual machine controller along with the scheduler controller migrates the VMs from the original logical dedicated host to the clone dedicated host.

In operation 412, in response to the original logical dedicated host being migrated, the completion of the dedicated host migration is initiated.

In operation 414, the migration controller deletes the original logical dedicated host object, prompting the scheduler microservice to de-provision the original logical dedicated host. The migration object is updated to a completed state.

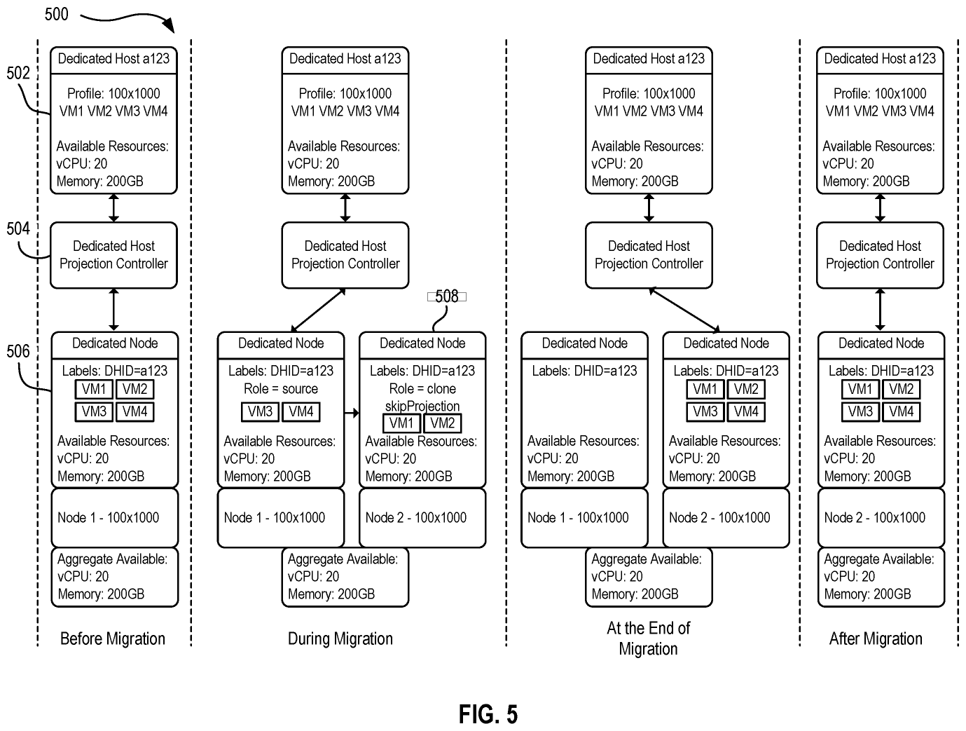

Now referring to FIG. 5, a diagram of an exemplary logical dedicated host migration process 500 is shown according to one approach. The process 500 may be performed in accordance with the present invention in any of the environments depicted in FIGS. 1-4, among others, in various approaches. Of course, more or fewer operations than those specifically described in FIG. 5 may be included in process 500, as would be understood by one of skill in the art upon reading the present descriptions.

Each of the steps of the process 500 may be performed by any suitable component of the operating environment. For example, in various approaches, the process 500 may be partially or entirely performed by a computer, or some other device having one or more processors therein. The processor, e.g., processing circuit(s), chip(s), and/or module(s) implemented in hardware and/or software, and preferably having at least one hardware component, may be utilized in any device to perform one or more steps of the process 500. Illustrative processors include, but are not limited to, a central processing unit (CPU), an application specific integrated circuit (ASIC), a field programmable gate array (FPGA), etc., combinations thereof, or any other suitable computing device known in the art.

As shown in the column entitled “before migration,” a logical dedicated host projection 502, for presentation to the user, indicates that the underlying components of a logical dedicated host have four VMs running thereon, and available resources of 20 virtual CPU (vCPU) and 200 gigabytes of memory left. Looking to the underlying components, a dedicated host projection controller 504 interfaces with a dedicated node 506, and projects the relevant parameters into the projection 502. The dedicated node 506 may be or include a physical server. Four VMs (VM1-VM4) are running on the dedicated node 506. Other characteristics such as node profile, labels, etc. are noted on the various components in arbitrary values for demonstration purposes only.

Referring next to the “during migration” column, a clone 508 of the dedicated node 506 is created. The dedicated nodes 506, 508 have the same characteristics. Two VMs are shown as having been migrated to the clone dedicated node 508. Though two dedicated nodes 506, 508 are now servicing the user, the characteristics projected to the user remain the same, e.g., as shown in the dedicated host projection 502. In this example, the parameters of the dedicated node 506 continue to be projected to the user. If the user makes changes, the changes are sent to the dedicated node 506, and propagated to the clone dedicated node 508 if needed, e.g., if the user makes a change regarding VM1 in this example.

Referring next to the “at the end of migration” column, the VMs are running on the clone dedicated node 508. The dedicated host projection controller 504 switches to the clone dedicated node 508 and begins projecting parameters thereof. The connection between the dedicated nodes 506, 508 is severed.

Referring next to the “after migration” column, all resources of the user now physically reside on a new dedicated host. The projection 502 retains the identity (DHID a123) and characteristics of the original logical dedicated host such that the user is unaware of the migration.

The following sections describe various exemplary sub-processes that may be implemented by any of the processes described herein, such as the methods depicted in FIGS. 2-5, according to various approaches to performing the methodology of the present invention. Each paragraph of the section generally corresponds to a particular operation of the sub-process.

### Dedicated Node Live Migration Initiation

A live migration schedule action for a dedicated node (referred to herein as logical dedicated node, DedicatedNode, or Source DedicatedNode) is initiated. The migration action targets the specified DedicatedHost ID.

The dedicated-node-migration-controller detects the requested live migration object and looks up the targeted DedicatedNode.

The dedicated-node-migration-controller creates a clone DedicatedNode for the specified DedicatedNode. The clone DedicatedNode is configured exactly the same as the source DedicatedNode. The clone and the source have differing DedicatedNode IDs, however, they are linked by a common label which identifies the ID of the original resource. In addition to the ID label, migration role labels are added to both DedicatedNodes, “source” for the original DedicatedNode and “destination” for the clone DedicatedNode.

The creation of the clone DedicatedNode gets detected by the dedicated-node-controller that creates a NodeReservation object for the clone DedicatedNode. The scheduler schedules the clone DedicatedNode and updates the NodeReservation with the new physical node. Once scheduled, the clone DedicatedNode object is updated with the assigned physical node. The clone is now scheduled and ready for use.

The DedicatedNodes (clone and source) are now in the proper state to initiate the VM migrations.

### Live Migrations for VirtualMachines (VMs)

A VM live migration action is initiated for a VirtualMachine on the Source DedicatedNode.

The scheduler can identify the placement target (i.e., the clone Dedicated Node) for the VM undergoing migration by looking at the DedicatedHost ID label and the MigrationRole label (value=destination).

The scheduler keeps track of the existing VMs on the source and accounts for the available resources of the clone DedicatedNode accordingly. This ensures that the clone DedicatedNode has the resources to host the existing VMs on the source.

As a VM is completely migrated to the clone DedicatedNode, the accounting of the available resources is updated by the scheduler for the source and the clone DedicatedNode accordingly.

The foregoing steps are repeated for all VMs running on the source DedicatedNode.

### New VirtualMachine Provisions During a DedicatedNode Live Migration.

To allow for totally transparent live migrations of DedicatedNodes, a user must still be able to perform all actions allowed for DedicatedNodes during the migration. An important part of this is the scheduling of new VMs to the DedicatedNode during the live migration of the DedicatedNode. This requires the aggregation of available resources on both the source DedicatedNode and the clone DedicatedNode.

The scheduler preferably attempts to always schedule any new VirtualMachines to the clone DedicatedNode. By always choosing the clone DedicatedNode for placement, the scheduler prevents the need for any more VirtualMachine migrations.

Once the clone DedicatedNode object has been selected by the scheduler for a new VM, additional validations of known type may be performed to ensure there are enough available resources to fulfill the request for the new VM. This entails aggregation of the available resources that exist on both the source DedicatedNode and the clone DedicatedNode. Details on aggregation are explained in the following section.

If there are enough resources available to meet the VMs requirements, then the VM is scheduled to the clone DedicatedNode. If there are not enough resources available, the new VM request is rejected.

### Finishing the DedicatedNode Live Migration

Once the source DedicatedNode no longer has any running VMs, the DedicatedNode live migration is ready to be completed.

It will be clear that the various features of the foregoing systems and/or methodologies may be combined in any way, creating a plurality of combinations from the descriptions presented above.

It will be further appreciated that aspects of the present invention may be provided in the form of a service deployed on behalf of a customer to offer service on demand.

The descriptions of the various aspects of the present invention have been presented for purposes of illustration, but are not intended to be exhaustive or limited to the approaches disclosed. Many modifications and variations will be apparent to those of ordinary skill in the art without departing from the scope and spirit of the described approaches. The terminology used herein was chosen to best explain the principles of the approaches, the practical application or technical improvement over technologies found in the marketplace, or to enable others of ordinary skill in the art to understand the approaches disclosed herein.

What is claimed is:

1. A computer-implemented method, comprising:
in response to receiving a request to migrate a logical dedicated host from a first physical server, creating a clone of the logical dedicated host thereby creating a clone dedicated host;
provisioning the clone dedicated host on a second physical server;
migrating virtual machines from the logical dedicated host to the clone dedicated host, wherein user operations being performed on the virtual machines continue uninterrupted during the migration of the virtual machines; and
in response to completion of the migrating of the virtual machines, causing the logical dedicated host to be de-provisioned.

2. The computer-implemented method of claim 1, wherein a resource configuration of the second physical server substantially matches the resource configuration of the first physical server.

3. The computer-implemented method of claim 1, wherein the virtual machines running on the clone dedicated host are presented to a user as running on the logical dedicated host during and after the migrating of the virtual machines, wherein the clone dedicated host is presented to the user as the logical dedicated host after completion of the migration of the logical dedicated host.

4. The computer-implemented method of claim 1, comprising:
in response to receiving the request, creating a migration object that is used to track the migration of the logical dedicated host;
acting on the migration object to create the clone dedicated host;
identifying the second physical server;
provisioning the clone dedicated host on the second physical server;
in response to provisioning the clone dedicated host on the second physical server, updating the migration object; and
initiating the migration of the virtual machines.

5. The computer-implemented method of claim 4, wherein causing the logical dedicated host to be de-provisioned includes deleting a logical dedicated host object, thereby prompting a scheduler microservice to de-provision the logical dedicated host; and comprising updating the migration object to a completed state.

6. The computer-implemented method of claim 1, comprising receiving a request to provision a new virtual machine from a user during the migrating of the virtual machines, and in response to the request to provision the new virtual machine, provisioning the new virtual machine on the clone dedicated host during the migrating.

7. The computer-implemented method of claim 6, wherein provisioning the new virtual machine on the clone dedicated host includes:
determining an aggregate amount of available resources of the logical dedicated host and the clone dedicated host;
determining whether the aggregate amount of available resources is sufficient to fulfill the request to provision the new virtual machine by comparing an amount of resources required by the new virtual machine to the aggregate amount of available resources; and
in response to determining that the aggregate amount of available resources is sufficient to fulfill the request for provisioning the new virtual machine, scheduling provisioning of the new virtual machine on the clone dedicated host.

8. The computer-implemented method of claim 1, comprising receiving a request to delete one of the virtual machines from a user during the migrating of the virtual machines; and deleting the one of the virtual machines during the migrating of the virtual machines in response to the request to delete the one of the virtual machines.

9. A computer program product for live migration of a logical dedicated host and virtual machines running thereon from a first physical server to a second physical server, the computer program product comprising:
one or more computer readable storage media, and program instructions collectively stored on the one or more computer readable storage media, the program instructions comprising:
program instructions to, in response to receiving a request to migrate a logical dedicated host from a first physical server, create a clone of the logical dedicated host thereby creating a clone dedicated host;
program instructions to provision the clone dedicated host on a second physical server;
program instructions to migrate virtual machines from the logical dedicated host to the clone dedicated host, wherein user operations being performed on the virtual machines continue uninterrupted during the migration of the virtual machines; and
program instructions to, in response to completion of the migrating of the virtual machines, cause the logical dedicated host to be de-provisioned.

10. The computer program product of claim 9, wherein a resource configuration of the second physical server substantially matches the resource configuration of the first physical server.

11. The computer program product of claim 9, wherein the virtual machines running on the clone dedicated host are presented to a user as running on the logical dedicated host during and after the migrating of the virtual machines, wherein the clone dedicated host is presented to the user as the logical dedicated host after completion of the migration of the logical dedicated host.

12. The computer program product of claim 9, comprising:
program instructions to, in response to receiving the request, create a migration object that is used to track the migration of the logical dedicated host;
program instructions to act on the migration object to create the clone dedicated host;
program instructions to identify the second physical server;
program instructions to provision the clone dedicated host on the second physical server;
program instructions to, in response to provisioning the clone dedicated host on the second physical server, update the migration object; and
program instructions to initiate the migration of the virtual machines.

13. The computer program product of claim 12, wherein causing the logical dedicated host to be de-provisioned includes deleting a logical dedicated host object, thereby prompting a scheduler microservice to de-provision the logical dedicated host; and comprising program instructions to update the migration object to a completed state.

14. The computer program product of claim 9, comprising program instructions to receive a request to provision a new virtual machine from a user during the migrating of the virtual machines, and in response to the request to provision the new virtual machine, provision the new virtual machine on the clone dedicated host during the migrating.

15. The computer program product of claim 14, wherein provisioning the new virtual machine on the clone dedicated host includes:
determining an aggregate amount of available resources of the logical dedicated host and the clone dedicated host;
determining whether the aggregate amount of available resources is sufficient to fulfill the request to provision the new virtual machine by comparing an amount of resources required by the new virtual machine to the aggregate amount of available resources; and
in response to determining that the aggregate amount of available resources is sufficient to fulfill the request for provisioning the new virtual machine, scheduling provisioning of the new virtual machine on the clone dedicated host.

16. The computer program product of claim 9, comprising program instructions to receive a request to delete one of the virtual machines from a user during the migrating of the virtual machines; and program instructions to delete the one of the virtual machines during the migrating of the virtual machines in response to the request to delete the one of the virtual machines.

17. A system, comprising:
a processor; and
logic integrated with the processor, executable by the processor, or integrated with and executable by the processor, the logic being configured to:
in response to receiving a request to migrate a logical dedicated host from a first physical server, create a clone of the logical dedicated host thereby creating a clone dedicated host;
provision the clone dedicated host on a second physical server;
migrate virtual machines from the logical dedicated host to the clone dedicated host, wherein user operations being performed on the virtual machines continue uninterrupted during the migration of the virtual machines; and
in response to completion of the migrating of the virtual machines, cause the logical dedicated host to be de-provisioned.

18. The system of claim 17, wherein a resource configuration of the second physical server substantially matches the resource configuration of the first physical server.

19. The system of claim 17, wherein the virtual machines running on the clone dedicated host are presented to a user as running on the logical dedicated host during and after the migrating of the virtual machines, wherein the clone dedicated host is presented to the user as the logical dedicated host after completion of the migration of the logical dedicated host.

20. The system of claim 17, comprising logic configured to:
in response to receiving the request, create a migration object that is used to track the migration of the logical dedicated host;
act on the migration object to create the clone dedicated host;
identify the second physical server;
provision the clone dedicated host on the second physical server;
in response to provisioning the clone dedicated host on the second physical server, update the migration object; and
initiate the migration of the virtual machines.
